(19) United States
(12) Patent Application Publication
(10) Pub. No.: US 2026/0060444 A1
(43) Pub. Date: Mar. 5, 2026

(54) CHILDREN BED

(71) Applicants: BABY TREND, INC., Fontana, CA (US); DONGGUAN GOLDEN PROSPER BABY PRODUCTS CO., LTD., Dongguan, Guangdong (CN)

(72) Inventors: Mark ASAI, Fontana, CA (US); Michael CAVINS, Fontana, CA (US); Chin-Kuan LAC, Fontana, CA (US); Jie HU, Fontana, CA (US); Shaoqin LI, Fontana, CA (US)

(73) Assignees: BABY TREND, INC., Fontana, CA (US); DONGGUAN GOLDEN PROSPER BABY PRODUCTS CO., LTD., Dongguan, Guangdong (CN)

(21) Appl. No.: 19/104,205

(22) PCT Filed: Aug. 14, 2023
(86) PCT No.: PCT/CN2023/112959

§ 371 Date: Feb. 14, 2025

(30) Foreign Application Priority Data
Aug. 15, 2022 (CN) 202222156156.1

(51) Int. Cl. A47D 7/00

(52) U.S. Cl. CPC A47D 7/002

(57) ABSTRACT

A children bed (100), comprising at least four vertical rods (10), horizontal rods (20), and sleeve cloth (30). The at least four vertical rods (10) are spaced apart from each other along a circumferential direction; each horizontal rod (20) is arranged between two adjacent vertical rods (10), the horizontal rod (20) comprises a foldable rod component (201) and a locking component (202) configured to lock or unlock the rod component (201), two ends of the rod component (201) are respectively movably connected to the two adjacent vertical rods (10), the locking component (202) comprises a trigger member (2022) and an inadvertent-touch-prevention member (2023), the trigger member (2022) can unlock the rod component (201) when triggered, the inadvertent-touch-prevention member (2023) is arranged on a front side of the trigger member (2022) facing a user; the sleeve cloth (30) is sleeved on a frame formed by the at least four vertical rods (10) and the horizontal rods (20), the sleeve cloth (30) is provided with an aperture (301) corresponding to each horizontal rod (20), the trigger member (2022) and the inadvertent-touch-prevention member (2023) are arranged in the corresponding aperture (301).

### CROSS REFERENCE TO RELATED APPLICATIONS

The present application claims the priority of the Chinese patent application with the application number of 202222156156.1, filed with the CNIPA on Aug. 15, 2022 and entitled “Children bed”, which is incorporated herein by reference in its entirety.

### TECHNICAL FIELD

The present application relates to the technical field of Children's furniture, in particular relates to a children bed.

### BACKGROUND

In the related art, an unlocking joint arranged at a circumferential side of a children bed is usually sleeved by sleeve cloth, and when using the children bed, a customer can only sense the position of the foldable joint by touching, it is not easy to find the unlocking position thereof, while it is easy to inadvertently touch other non-unlocking components.

### SUMMARY OF THE APPLICATION

The present application aims at solving at least one of technical problems in the prior art. To this end, one purpose of the present application is to provide a children bed, to solve the problem in the prior art that a user can only sense the position of the foldable joint by touching while it is easy to inadvertently touch other non-unlocking components.

According to the children bed of embodiments of the present application, the children bed includes: at least four vertical rods, spaced apart from each other along a circumferential direction; horizontal rods, wherein each horizontal rod is arranged between two adjacent vertical rods, the horizontal rod comprises a foldable rod component and a locking component configured to lock or unlock the rod component, two ends of the rod component are respectively movably connected to the two adjacent vertical rods, the locking component comprises a trigger member and an inadvertent-touch-prevention member, the trigger member can unlock the rod component when triggered, the inadvertent-touch-prevention member is arranged on a front side of the trigger member facing a user; and sleeve cloth, sleeved on a frame formed by the at least four vertical rods and the horizontal rods, wherein the sleeve cloth is provided with an aperture corresponding to each horizontal rod, the trigger member and the inadvertent-touch-prevention member are arranged in the corresponding aperture.

According to the children bed of embodiments of the present application, the sleeve cloth is sleeved on a frame formed by the at least four vertical rods, which are spaced apart from each other along a circumferential direction, and the horizontal rods, each of which is arranged between two adjacent vertical rods, and the sleeve cloth is provided with an aperture corresponding to each horizontal rod, and at the same time, the horizontal rod includes a foldable rod component and a locking component configured to lock or unlock the rod component, and by arranging the trigger member and the inadvertent-touch-prevention member of the locking component in the corresponding aperture, when unlocking the locking component of the horizontal rod, it is easy for a user to find the trigger member to perform the unlocking operation, and at the same time, the user is prevented from touching the trigger member inadvertently.

In some embodiments, the locking component further includes: a fixing seat, movably connected with the rod component, wherein the trigger member is movably arranged on the fixing seat to be movable along an up-and-down direction, the trigger member can be moved to unlock the rod component when triggered, so as to enable the rod component to be folded on the fixing seat, and the inadvertent-touch-prevention member is arranged on the fixing seat.

In some embodiments, an accommodating space is formed inside the fixing seat, the fixing seat is provided with an opening communicated with the accommodating space, the trigger member is arranged in the accommodating space, and the trigger member is at least partially located in the opening at its initial position.

In some embodiments, the inadvertent-touch-prevention member covers at least part of the opening, or the inadvertent-touch-prevention member is an annular flange part arranged around an edge of the opening.

In some embodiments, the inadvertent-touch-prevention member is integrally formed with the fixing seat; or the inadvertent-touch-prevention member is detachably arranged on the fixing seat.

In some embodiments, a detachable structure, which comprises a buckle and a slot, is arranged between the annular flange part and the fixing seat, one of the buckle and the slot is arranged on the fixing seat, and the other of the buckle and the slot is arranged on the annular flange part, the slot or the buckle is arranged near the opening.

In some embodiments, when the inadvertent-touch-prevention member is the annular flange part, a circumferential edge of the opening is provided with a protruding edge, and the annular flange part is internally fitted on the protruding edge.

In some embodiments, the rod component includes: a first rod section, wherein one end of the first rod section is pivotably arranged on the fixing seat, and the other end of the first rod section is pivotably arranged on one of the two adjacent vertical rods; a second rod section, wherein one end of the second rod section is pivotably arranged on the fixing seat, and the other end of the second rod section is pivotably arranged on the other of the two adjacent vertical rods.

In some embodiments, the trigger member includes: a first locking part, kept engaging with the first rod section and the fixing seat in a constant state thereof, a second locking part, kept engaging with the second rod section and the fixing seat in a constant state thereof; a pressing part, moveably arranged in the accommodating space to be movable along an up-and-down direction and located in the opening, wherein the pressing part is movable in coordination with the first locking part and the second locking part, and when the pressing part is driven to move upward, it causes the first locking part to be disengaged from the first rod section and causes the second locking part to be disengaged from the second rod section.

In some embodiments, the fixing seat incudes: a fixing frame, wherein the accommodating space and the opening are formed in the fixing frame, a breach is formed at a top part of the fixing frame, the opening is arranged at a lower part of the fixing frame, and the inadvertent-touch-prevention member is arranged on the fixing frame; a connecting bracket, arranged in the breach, wherein the first locking part and the second locking part are moveably arranged on the connecting bracket, the first rod section and the second rod section are connected to the connecting bracket, and the pressing part is moveably arranged on the connecting bracket.

Additional aspects and advantages of the present application will be partially described below, and will partially become apparent from the following description, or will be learned from practice of the present application.

### BRIEF DESCRIPTION OF THE DRAWINGS

The above described and/or additional aspects and advantages of the present application will become apparent and easy to understand in conjunction with the description of embodiments with reference to the accompanying drawings hereinafter, wherein:

FIG. 1 is a perspective schematic structural diagram of a children bed in an embodiment of the present application;

FIG. 2 is an enlarged view at part I in FIG. 1 of the present application;

FIG. 3 is a schematic diagram of the children bed with the sleeve cloth removed in an embodiment of the present application;

FIG. 4 is an exploded view of a horizontal rod in an embodiment of the present application;

FIG. 5 is a schematic diagram of the horizontal rod in a folded status after being unlocked in an embodiment of the present application;

FIG. 6 is a schematic diagram of a horizontal rod in an unfolded status after being locked in an embodiment of the present application;

FIG. 7 is a schematic diagram of a fixing frame in an embodiment of the present application;

FIG. 8 is a schematic assembling diagram of the fixing frame and an inadvertent-touch-prevention member in an embodiment of the present application.

### REFERENCE NUMERALS

100. Children bed; 10. Vertical rod; 20. Horizontal rod; 201. Rod component; 2011. First rod section; 2012. Second rod section; 202. Locking component; 2021. Fixing seat; 20211. Fixing frame; 20211a. Accommodating space; 20211b. Opening; 20211c. protruding edge; 20211d. Breach; 20212. Connecting bracket; 2022. Trigger member; 20221. First locking part; 20222. Second locking part; 20223. Pressing part; 2023. Inadvertent-touch-prevention member; 2024. Detachable structure; 20241. Buckle; 20242. Slot; 30. Sleeve cloth; 301. Aperture.

### DETAILED DESCRIPTION

Embodiments of the present application are described in detail below, and examples of the embodiments are shown in the accompanying drawings, wherein the same or similar reference numerals throughout denote the same or similar elements or those elements having the same or similar functions. The embodiments described below with reference to the accompanying drawings are exemplary and are merely used for explaining the present application, rather than being construed as a limitation to the present application.

In the description of the present application, it should be understood that the orientation or position relations indicated by the terms “center”, “length”, “upper”, “lower”, “front”, “back”, “left”, “right”, “vertical”, “horizontal”, “top”, “bottom”, “inner”, “outer”, and the like are orientation or position relations illustrated based on the drawings, and are merely for the convenience of describing the present application and simplifying the description, and are not intended to indicate or imply the denoted device or element must have a specific orientation or must be constructed and operated in a specific orientation. Therefore, such terms should not be construed as limiting the present application.

In addition, a feature referred to by the terms such as “first” or “second” may explicitly or implicitly include one or more such features, and such terms are used to distinguish and describe the features without limiting any sequence or importance thereof.

In the description of the present application, the term “plurality” means two or more unless otherwise stated.

In the description of the present application, it should be noted that, unless otherwise clearly specified and defined, the terms “installed”, “coupled” and “connected” should be understood in a broad sense, for example, it may indicate fixed connection, or detachable connection, or integral connection; it may indicate mechanical connection, or electrical connection; it may indicate direct connection, or indirect connection through an intermediate medium, or internal communication between two components. For a person with ordinary skill in the art, specific meanings of the above-mentioned terms in the present application may be construed according to specific circumstances thereof.

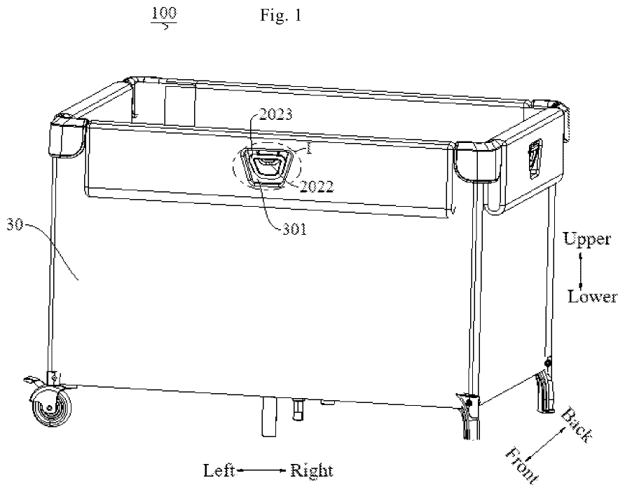

The children bed 100 according to an embodiment of the present application is described below with reference to FIGS. 1 to 8.

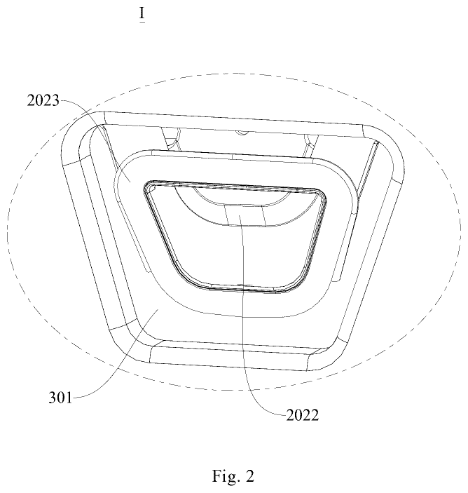

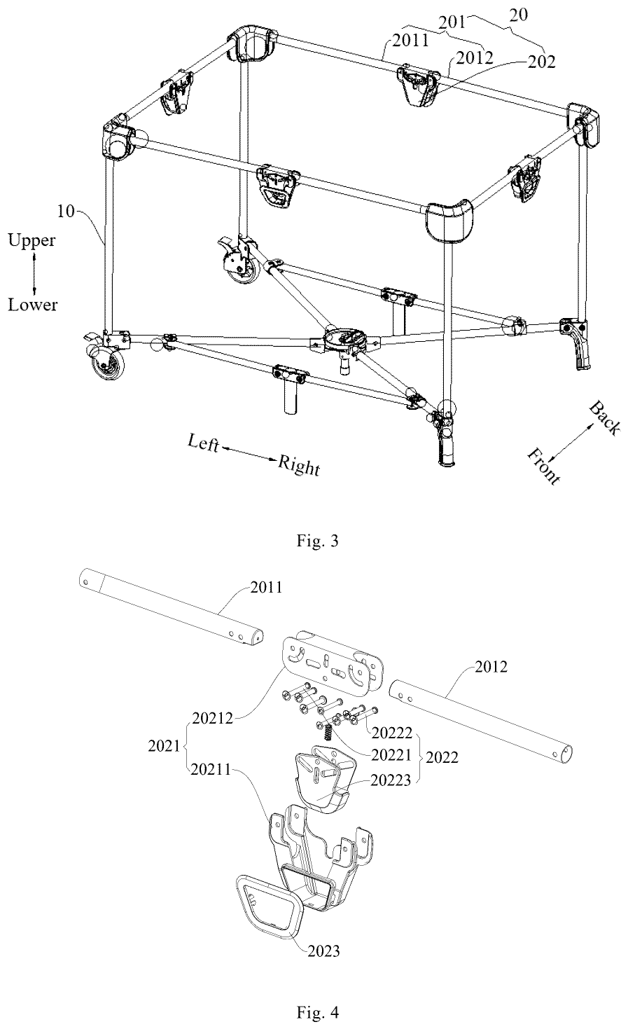

As shown in FIG. 1, FIG. 2, and FIG. 3, the children bed 100 according to an embodiment of the present application includes: at least four vertical rods 10, horizontal rods 20 and sleeve cloth 30.

The at least four vertical rods 10 are spaced apart from each other along a circumferential direction; each horizontal rod 20 is arranged between two adjacent vertical rods 10, the horizontal rod 20 includes a foldable rod component 201 and a locking component 202 configured to lock or unlock the rod component 201, two ends of the rod component 201 are respectively movably connected to the two adjacent vertical rods 10, the locking component 202 includes a trigger member 2022 and an inadvertent-touch-prevention member 2023, the trigger member 2022 can unlock the rod component 201 when triggered, the inadvertent-touch-prevention member 2023 is arranged on a front side of the trigger member 2022 facing a user; and the sleeve cloth 30 is sleeved on a frame formed by the at least four vertical rods 10 and the horizontal rods 20, the sleeve cloth 30 is provided with an aperture 301 corresponding to each horizontal rod 20, the trigger member 2022 and the inadvertent-touch-prevention member 2023 are arranged in the corresponding aperture 301.

It can be understood that, there may be at least four vertical rods 10, and the at least four vertical rods 10 together with the horizontal rods 20 form a frame structure, and as shown in FIG. 3, there are four vertical rods 10 and four horizontal rods 20, they together form a rectangular frame. The sleeve cloth 30 is wrapped around side faces of the frame, as well as wrapped around the vertical rods 10 and the horizontal rods 20, the rod component 201 is kept unfolded in a constant state thereof under the action of the locking component 202, so as to maintain the formed frame structure, the trigger member 2022 can unlock the rod component 201 when triggered, and at this time the rod component 201 can be folded, such that the children bed 100 is folded up as a whole.

In the conventional technical solution, the locking component 202 is covered by the sleeve cloth 30, and when a user needs to fold the rod component 201, the user can only touch the locking component 202 by blindly feeling it, therefore, it is not easy to find the locking component 202, while it is easy to touch non-locking components inadvertently, and in the meantime, in the conventional technology, when the rod component 201 is being folded by pressing the locking component 202, the sleeve cloth 30 can easily be clamped by the locking component 202, resulting in damage thereof. In the present application, the sleeve cloth 30 is provided with an aperture 301, the aperture 301 may be provided on a front side, an upper side, a left side, or a right side of the sleeve cloth 30, which can be specifically arranged according to the location of the user, wherein the aperture 301 should always be in front of the user, and when the user needs to fold up the children bed 100, since the aperture 301 makes the trigger member 2022 and the inadvertent-touch-prevention member 2023 of the locking component 202 exposed out of the sleeve cloth 30, the user can observe the trigger member 2022 directly through the aperture 301, so as to enable the user to find the trigger member 2022 easily, therefore the user can trigger the trigger member 2022 and unlock the rod component 201 timely and accurately, and at the same time, the arrangement of the inadvertent-touch-prevention member 2023 can prevent the user from touching the trigger member 2022 inadvertently.

According to the children bed 100 of embodiments of the present application, the sleeve cloth 30 is sleeved on the frame formed by the at least four vertical rods 10, which are spaced apart from each other along a circumferential direction, and the horizontal rods 20, each of which is arranged between two adjacent vertical rods 10, and the sleeve cloth 30 is provided with an aperture 301 corresponding to each horizontal rod 20, and at the same time, the horizontal rod 20 includes a foldable rod component 201 and a locking component 202 configured to lock or unlock the rod component 201, and by arranging the trigger member 2022 and the inadvertent-touch-prevention member 2023 of the locking component 202 in the corresponding aperture 301, when locking or unlocking the locking component 202 of the horizontal rod 20, the user is enabled to find the trigger member 2022 easily to perform the locking or unlocking operation, while preventing the user from touching the trigger member 2022 inadvertently.

In some embodiments, as shown in FIG. 4, the locking component 202 further includes a fixing seat 2021, the fixing seat 2021 is movably connected with the rod component 201, the trigger member 2022 is movably arranged on the fixing seat 2021 to be movable along an up-and-down direction, the trigger member 2022 can be moved to unlock the rod component 201 when triggered, so as to enable the rod component 201 to be folded on the fixing seat 2021, and the inadvertent-touch-prevention member 2023 is arranged on the fixing seat 2021. It can be understood that, the fixing seat 2021 acts as a support for the rod component 201 and the trigger member 2022, providing an installation location to facilitate the installation of the rod component 201 and the trigger member 2022. Specifically, when the rod component 201 needs to be unlocked, the trigger member 2022 is pressed upward, and thereby the trigger member 2022 can be moved upward on the fixing seat, so as to enable the trigger member 2022 to move more reliably, the rod component 201 can be unlocked after the trigger member 2022 is moved upward, and then the rod component 201 can be folded.

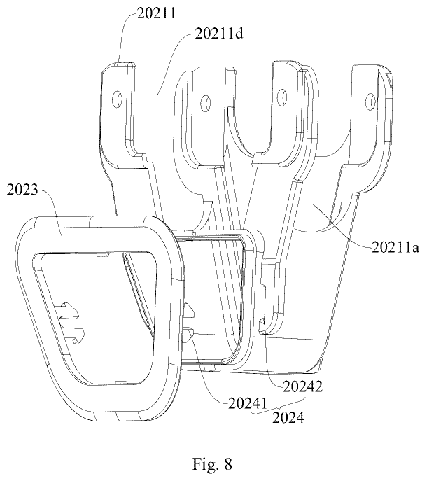

In some embodiments, as shown in FIG. 7, an accommodating space 2011a is formed inside the fixing seat 2021, the fixing seat 2021 is provided with an opening 20211b communicated with the accommodating space 2011a, the trigger member 2022 is arranged in the accommodating space 2011a, and the trigger member 2022 is at least partially located in the opening 20211b at its initial position. Specifically, the fixing seat 2021 is a hollow structure with the accommodating space 2011a, the trigger member 2022 can be placed in the accommodating space 2011a, so as to ensure the safety of the trigger member 2022, and also to make the overall structure more compact. When the trigger member 2022 is at its initial position, at least part of the trigger member 2022 is located in the opening 20211b, that is to say, the trigger member 2022 can be hidden in the opening 20211b, which can further have an effect of preventing inadvertent touch, wherein the trigger member 2022 may be partially located in the opening 20211b, or the trigger member 2022 may be entirely located in the opening 20211b.

In some embodiments, as shown in FIG. 8, the inadvertent-touch-prevention member 2023 covers at least part of the opening 20211b. Specifically, the inadvertent-touch-prevention member 2023 may be a cover structural component, and covers the opening 20211b, and when the user needs to fold up the children bed 100, the user firstly opens the inadvertent-touch-prevention member 2023 through the aperture 301 to expose the opening 20211b, and then the user becomes able to operate the trigger member 2022. Wherein the inadvertent-touch-prevention member 2023 may cover part of the opening 20211b or may cover the entire opening 20211b.

In other embodiments, as shown in FIG. 8, the inadvertent-touch-prevention member 2023 is an annular flange part arranged around an edge of the opening 20211b. Specifically, the configuration of the inadvertent-touch-prevention member 2023 is annular, which is arranged around the edge of the opening 20211b, that is to say, a distance between the trigger member 2022 and an outer edge of the annular flange part is relatively large, such that, when the user's hand touches the aperture 301 inadvertently, the trigger member 2022 will not be triggered at this time due to being blocked by the annular flange part, and it is only when the user consciously passes his/her hand through both the annular flange part and the opening 20211b to operate the trigger member 2022 that the rod component 201 can be unlocked and folded.

In some embodiments, the inadvertent-touch-prevention member 2023 is integrally formed with the fixing seat 2021. That is to say, the two are formed as one piece, thereby the inadvertent-touch-prevention member 2023 can be installed and demounted together with the fixing seat 2021, so as to reduce the number of parts and improve assembly efficiency.

In other embodiments, the inadvertent-touch-prevention member 2023 is detachably arranged on the fixing seat 2021. Specifically, the inadvertent-touch-prevention member 2023 may be detachably mounted on the fixing seat 2021 according to the user's requirements, and when the inadvertent-touch-prevention member 2023 or the fixing seat 2021 is damaged, only the damaged part needs to be replaced with a new part, and those undamaged parts don't need to be replaced, so as to reduce the maintenance cost.

In some embodiments, as shown in FIG. 8, a detachable structure 2024 is arranged between the annular flange part and the fixing seat 2021, the detachable structure 2024 comprises a buckle 20241 and a slot 20242, one of the buckle 20241 and the slot 20242 is arranged on the fixing seat 2021, and the other of the buckle and the slot is arranged on the annular flange part, the slot 20242 or the buckle 20241 are arranged near the opening 20211b. Specifically, the annular flange part and the fixing seat 2021 are connected with each other by means of the structure of the buckle 20241 and the slot 20242, it is relatively simple, easy to be demounted and installed, and can ensure the stability of the structure.

For example, the slot 20242 may be arranged on the annular flange part, while the buckle 20241 may be arranged on the fixing seat 2021; and alternatively, the buckle 20241 may also be arranged on the annular flange part, while the slot 20242 may be arranged on the fixing seat 2021, users can choose one of the arrangements according to their needs.

In some embodiments, as shown in FIG. 7, when the inadvertent-touch-prevention member 2023 is the annular flange part, a circumferential edge of the opening 20211b is provided with a protruding edge 20211c, and the annular flange part is internally fitted on the protruding edge 20211c. By internally fitting the annular flange part on the protruding edge 20211c, the installation reliability of the annular flange part is enhanced.

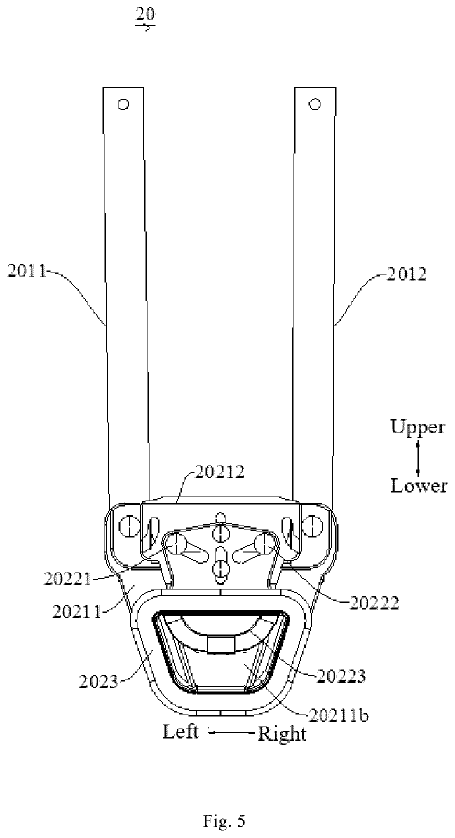

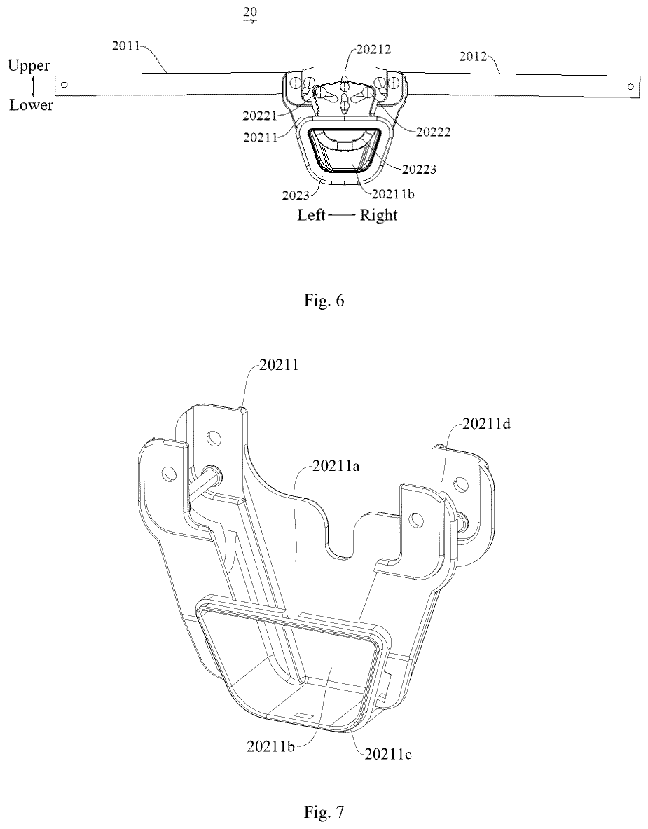

In some embodiments, as shown in FIG. 4 to FIG. 6, the rod component 201 includes a first rod section 2011 and a second rod section 2012, one end of the first rod section 2011 is pivotably arranged on the fixing seat 2021, and the other end of the first rod section is pivotably arranged on one of the two adjacent vertical rods 10; one end of the second rod section 2012 is pivotably arranged on the fixing seat 2021, and the other end of the second rod section is pivotably arranged on the other of the two adjacent vertical rods 10. That is to say, when the rod component 201 is unlocked by the trigger member 2022, the first rod section 2011 and the second rod section 2012 can pivot around the fixing seat 2021, as shown in FIG. 5, the first rod section 2011 and the second rod section 2012 are folded in a direction towards each other; and when the rod component 201 needs to be unfolded, the first rod section 2011 and the second rod section 2012 can be unfolded in a direction away from each other, and after they are unfolded to the final position (referring to FIG. 6), the rod component 201 can be locked by the trigger member 2022.

In some embodiments, as shown in FIG. 4, the trigger member 2022 comprises a first locking part 20221, a second locking part 20222 and a pressing part 20223, the first locking part 20221 is kept engaging with the first rod section 2011 and the fixing seat 2021 in a constant state thereof; the second locking part 20222 is kept engaging with the second rod section 2012 and the fixing seat 2021 in a constant state thereof; the pressing part 20223 is moveably arranged in the accommodating space 20211a to be movable along an up-and-down direction and located in the opening 20211b, the pressing part 20223 is movable in coordination with the first locking part 20221 and the second locking part 20222, and when the pressing part 20223 is driven to move upward, it causes the first locking part 20221 to be disengaged from the first rod section 2011 and causes the second locking part 20222 to be disengaged from the second rod section 2012. Specifically, while the user pushes the pressing part 20223 upward, after the pressing part 20223 is moved upward, the first locking part 20221 and the second locking part 20222 will both move toward the pressing part 20223, so as to cause the first rod section 2011 and the second rod section 2012 to be disengaged from the limitation of the first locking part 20221 and the second locking part 20222 respectively, and thus become able to be folded.

For example, the pressing part 20223 is a movable block, the first locking part 20221 is a first locking column, the second locking part 20222 is a second locking column, the first locking column and the second locking column may be slidably connected to the fixing seat 2021, as mentioned above, the first rod section 2011 and the second rod section 2012 are pivotably connected to the fixing seat 2021, the first locking column is kept abutting against the first rod section 2011 in its initial state, the second locking column is kept abutting against the second rod section 2012 in its initial state, at this time, the first rod section 2011 and the second rod section 2012 are both in a locked state, and cannot be pivoted. When the movable block is moved, the first locking column is driven to move to be disengaged from the first rod section 2011, the second locking column is driven to move to be disengaged from the second rod section 2012, at this time, the first rod section 2011 and the second rod section 2012 are both in an unlocked state, and can be pivoted and folded.

In some embodiments, as shown in FIG. 4, the fixing seat 2021 includes a fixing frame 20211 and a connecting bracket 20212, the accommodating space 20211a and the opening 20211b are formed in the fixing frame 20211, a breach 20211d is formed at a top part of the fixing frame 20211, the opening 20211b is arranged at a lower part of the fixing frame 20211, and the inadvertent-touch-prevention member 2023 is arranged on the fixing frame 20211; the connecting bracket 20212 is arranged in the breach 20211d, the first locking part 20221 and the second locking part 20222 are moveably arranged on the connecting bracket 20212, the first rod section 2011 and the second rod section 2012 are connected to the connecting bracket 20212, and the pressing part 20223 is moveably arranged on the connecting bracket 20212. Specifically, the first rod section 2011 and the second rod section 2012 are pivotably connected to the connecting bracket 20212, and when the first rod section 2011 and the second rod section 2012 are in their initial unfolded state, the first locking part 20221 restricts the movement of the first rod section 2011, and the second locking part 20222 restricts the movement of the second rod section 2012. When the user pushes the pressing part 20223 upward, the first locking part 20221 and the second locking part 20222 are caused to move towards each other, so that the first rod section 2011 and the second rod section 2012 can be pivoted on the connecting bracket 20212, to achieve a state of being folded opposite to each other.

That is to say, the fixing seat 2021 is formed from two separate parts including the fixing frame 20211 and the connecting bracket 20212, so as to reduce the difficulty of using open molds, to facilitate the replacement of damaged parts separately and to reduce maintenance costs. At the same time, when being assembled, they can be assembled in sequence, thereby reducing the difficulty of assembly.

A specific embodiment of the child bed 100 of the present application is described below in conjunction with the accompanying drawings.

As shown in FIG. 1 to FIG. 8, the children bed according to an embodiment of the present application includes: four vertical rods 10, horizontal rods 20 and sleeve cloth 30.

The four vertical rods 10 are spaced apart from each other along a circumferential direction; each horizontal rod 20 is arranged between two adjacent vertical rods 10, the horizontal rod 20 includes the foldable rod component 201 and the locking component 202 configured to lock or unlock the rod component 201, two ends of the rod component 201 are respectively movably connected to the two adjacent vertical rods 10, the locking component 202 includes the trigger member 2022 and the inadvertent-touch-prevention member 2023, the trigger member 2022 can unlock the rod component 201 when triggered, the inadvertent-touch-prevention member 2023 is arranged on a front side of the trigger member 2022 facing a user; the sleeve cloth 30 is sleeved on a frame formed by the four vertical rods 10 and the horizontal rods 20, the sleeve cloth 30 is provided with an aperture 301 corresponding to each horizontal rod 20, the trigger member 2022 and the inadvertent-touch-prevention member 2023 are arranged in the corresponding aperture 301.

The locking component 202 further includes a fixing seat 2021, the fixing seat 2021 is movably connected with the rod component 201, the trigger member 2022 is movably arranged on the fixing seat 2021 to be movable along an up-and-down direction, the trigger member 2022 can be moved to unlock the rod component 201 when triggered, so as to enable the rod component 201 to be folded on the fixing seat 2021, and the inadvertent-touch-prevention member 2023 is arranged on the fixing seat 2021.

An accommodating space 20211a is formed inside the fixing seat 2021, the fixing seat 2021 is provided with an opening 20211b communicated with the accommodating space 20211a, the trigger member 2022 is arranged in the accommodating space 20211a, and the trigger member 2022 is partially located in the opening 20211b at its initial position. The inadvertent-touch-prevention member 2023 is an annular flange part arranged around an edge of the opening 20211b. The inadvertent-touch-prevention member 2023 is detachably arranged on the fixing seat 2021.

A detachable structure 2024 is arranged between the annular flange part and the fixing seat 2021, the detachable structure 2024 includes a buckle 20241 and a slot 20242, the buckle 20241 is arranged on the annular flange part, the slot 20242 is arranged on the fixing seat 2021, and the slot 20242 is arranged near the opening 20211b.

A circumferential edge of the opening 20211b is provided with a protruding edge 20211c, and the annular flange part is internally fitted on the protruding edge 20211c.

The rod component 201 includes a first rod section 2011 and a second rod section 2012, one end of the first rod section 2011 is pivotably arranged on the fixing seat 2021, and the other end of the first rod section is pivotably arranged on a vertical rod 10 on the left; one end of the second rod section 2012 is pivotably arranged on the fixing seat 2021, and the other end of the second rod section is pivotably arranged on a vertical rod 10 on the right.

The trigger member 2022 includes a first locking part 20221, a second locking part 20222 and a pressing part 20223, the first locking part 20221 is kept engaging with the first rod section 2011 and the fixing seat 2021 in a constant state thereof, the second locking part 20222 is kept engaging with the second rod section 2012 and the fixing seat 2021 in a constant state thereof; the pressing part 20223 is moveably arranged in the accommodating space 20211a to be movable along an up-and-down direction and located in the opening 20211b, the pressing part 20223 is movable in coordination with the first locking part 20221 and the second locking part 20222, and when the pressing part 20223 is driven to move upward, it causes the first locking part 20221 to be disengaged from the first rod section 2011 and causes the second locking part 20222 to be disengaged from the second rod section 2012.

The fixing seat 2021 includes a fixing frame 20211 and a connecting bracket 20212, the accommodating space 20211a and the opening 20211b are formed in the fixing frame 20211, a breach 20211d is formed at a top part of the fixing frame 20211, the opening 20211b is arranged at a lower part of the fixing frame 20211, and the inadvertent-touch-prevention member 2023 is arranged on the fixing frame 20211; the connecting bracket 20212 is arranged in the breach 20211d, the first locking part 20211 and the second locking part 20222 are moveably arranged on the connecting bracket 20212, the first rod section 2011 and the second rod section 2012 are connected to the connecting bracket 20212, and the pressing part 20223 is moveably arranged on the connecting bracket 20212.

In the description of the present specification, description of reference terms including “some embodiments”, “optionally”, “further”, or “some examples” means that specific features, structures, materials, or characteristics described in combination with this embodiment or example are included in at least one embodiment or example of the present application. In the present specification, schematic expressions of the above terms do not necessarily refer to the same embodiment or example. Moreover, the described specific features, structures, materials or characteristics may be combined in a proper manner in any one or more embodiments or examples.

Although embodiments of the present application have been shown and described, it can be understood by a person skilled in the art that various changes, modifications, substitutions and variations can be made to these embodiments without departing from the principles and purposes of the present application, and that the scope of the present application is defined by the claims and their equivalents.

1. A children bed, comprising:
at least four vertical rods, spaced apart from each other along a circumferential direction;
horizontal rods, wherein each horizontal rod is arranged between two adjacent vertical rods, the horizontal rod comprises a foldable rod component and a locking component configured to lock or unlock the rod component, two ends of the rod component are respectively movably connected to the two adjacent vertical rods, the locking component comprises a trigger member and an inadvertent-touch-prevention member, the trigger member can unlock the rod component when triggered, the inadvertent-touch-prevention member is arranged on a front side of the trigger member facing a user; and
sleeve cloth, sleeved on a frame formed by the at least four vertical rods and the horizontal rods, wherein the sleeve cloth is provided with an aperture corresponding to each horizontal rod, the trigger member and the inadvertent-touch-prevention member are arranged in the corresponding aperture.

2. The children bed according to claim 1, wherein the locking component further comprises:
a fixing seat, movably connected with the rod component, wherein the trigger member is movably arranged on the fixing seat to be movable along an up-and-down direction, the trigger member can be moved to unlock the rod component when triggered, so as to enable the rod component to be folded on the fixing seat, and the inadvertent-touch-prevention member is arranged on the fixing seat.

3. The children bed according to claim 2, wherein an accommodating space is formed inside the fixing seat, the fixing seat is provided with an opening communicated with the accommodating space, the trigger member is arranged in the accommodating space, and the trigger member is at least partially located in the opening at its initial position.

4. The children bed according to claim 3, wherein the inadvertent-touch-prevention member covers at least part of the opening, or the inadvertent-touch-prevention member is an annular flange part arranged around an edge of the opening.

5. The children bed according to claim 4, wherein the inadvertent-touch-prevention member is integrally formed with the fixing seat; or the inadvertent-touch-prevention member is detachably arranged on the fixing seat.

6. The children bed according to claim 5, wherein a detachable structure, which comprises a buckle and a slot, is arranged between the annular flange part and the fixing seat, one of the buckle and the slot is arranged on the fixing seat, and the other of the buckle and the slot is arranged on the annular flange part, the buckle and the slot are arranged near the opening.

7. The children bed according to claim 4, wherein, when the inadvertent-touch-prevention member is the annular flange part, a circumferential edge of the opening is provided with a protruding edge, and the annular flange part is internally fitted on the protruding edge.

8. The children bed according to claim 3, wherein the rod component comprises:
a first rod section, wherein one end of the first rod section is pivotably arranged on the fixing seat, and the other end of the first rod section is pivotably arranged on one of the two adjacent vertical rods;
a second rod section, wherein one end of the second rod section is pivotably arranged on the fixing seat, and the other end of the second rod section is pivotably arranged on the other of the two adjacent vertical rods.

9. The children bed according to claim 8, wherein the trigger member comprises:
a first locking part, kept engaging with the first rod section and the fixing seat in a constant state thereof;
a second locking part, kept engaging with the second rod section and the fixing seat in a constant state thereof;
a pressing part, moveably arranged in the accommodating space to be movable along an up-and-down direction and located in the opening, wherein the pressing part is movable in coordination with the first locking part and the second locking part, and when the pressing part is driven to move upward, it causes the first locking part to be disengaged from the first rod section and causes the second locking part to be disengaged from the second rod section.

10. The children bed according to claim 9, wherein the fixing seat comprises:
a fixing frame, wherein the accommodating space and the opening are formed in the fixing frame, a breach is formed at a top part of the fixing frame, the opening is arranged at a lower part of the fixing frame, and the inadvertent-touch-prevention member is arranged on the fixing frame;
a connecting bracket, arranged in the breach, wherein the first locking part and the second locking part are moveably arranged on the connecting bracket, the first rod section and the second rod section are connected to the connecting bracket, and the pressing part is moveably arranged on the connecting bracket.
